(19) United States
(12) Patent Application Publication
(10) Pub. No.: US 2010/0059435 A1
(43) Pub. Date: Mar. 11, 2010

(54) CHEMICAL FILTER AND METHOD FOR PRODUCING THE SAME

(75) Inventors: Akihiro Imai, Yokohama-shi (JP); Takashi Tanahashi, Yokohama-shi (JP); Toshiro Nakano, Yokohama-shi (JP); Tainen Shimotsu, Yokohama-shi (JP); Shiro Ishiwata, Tokyo (JP); Takashi Shimonosono, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NICHIAS CORPORATION, Tokyo (JP)

(21) Appl. No.: 12/539,721

(22) Filed: Aug. 12, 2009

(30) Foreign Application Priority Data
Sep. 9, 2008 (JP) 2008-230694

(51) Int. Cl. B01D 39/18; C08F 2/46; B01D 39/16

(52) U.S. Cl. 210/493.1; 427/487; 210/502.1

(57) ABSTRACT

A chemical filter obtained by fabricating a chemical filter material, the chemical filter material being a woven or nonwoven fabric formed from a hydroxyl group-containing organic fiber, the hydroxyl group-containing organic fiber containing cation exchange groups introduced by radiation graft polymerization, the chemical filter material having an ion-exchange capacity of 400 meq/m² or more with respect to the cation exchange groups, and the chemical filter material having a tensile strength of 5 to 20 N/15 mm.

### BACKGROUND OF THE INVENTION

1. Field of the Invention

The present invention relates to a chemical filter which is used to remove malodorous substances from a gas or liquid, or installed in a clean room provided in a plant for manufacturing semiconductor devices, liquid crystal displays, or precision electronic components or in equipment used in such a clean room to remove ionic gaseous impurities, for example.

2. Description of Related Art

In forefront industries such as the semiconductor manufacturing industry and the liquid crystal manufacturing industry, it is important to control clean room air pollution and product surface pollution in order to ensure the yield, quality, and reliability of the products. In the semiconductor manufacturing industry, since the degree of integration of products has increased, it has become indispensable to control ionic gaseous pollutants (basic gas and acidic gas) in addition to controlling particles using an HEPA filter, a ULPA filter, or the like. For example, ammonia which is a basic gas adversely affects resolution or causes the wafer surface to become clouded during exposure employed in semiconductor production. On the other hand, SO_{X} which is an acidic gas causes substrate lamination defects when forming a thermal oxide film during semiconductor production, whereby the device characteristics and reliability deteriorate.

Since ionic gaseous pollutants cause various problems during semiconductor production or the like, it is desired to reduce the concentration of ionic gaseous pollutants in a clean room used in semiconductor production or the like to 1 ppb or less.

In this case, a chemical filter obtained by fabricating a nonwoven fabric with ion-exchange groups introduced therein is used. For example, JP-A-11-290702 (Patent Document 1) discloses a chemical filter using a nonwoven fabric of polyolefin fiber having an average fiber diameter of 10 μm or less produced by a melt blow method which is a type of span bond method, wherein the chemical filter is provided with ion-exchange capability by graft polymerization using ultraviolet rays, a chemical filter using a nonwoven fabric prepared by a hydroentanglement method, in which webs are formed from polyolefin fiber having an average fiber diameter of 10 μm or less produced by a melt blow method, wherein the chemical filter is provided with ion-exchange capability by graft polymerization using ultraviolet rays, and a chemical filter using a nonwoven fabric prepared by integrally laminating at least two layers of a web formed from polyolefin fiber having an average fiber diameter of 10 μm or less prepared by a melt blow method and a web having an average fiber diameter of 50 μm or less prepared by a span bond method or a staple fiber web by obtained hot press-bonding, wherein the chemical filter is provided with ion-exchange capabilities by graft polymerization using ultraviolet rays.

JP-A-8-199480 (Patent Document 2) discloses a gas adsorbing material obtained by subjecting a nonwoven fabric obtained by a thermal bond method using a fiber with a core-sheath structure to radiation grafting to introduce ion-exchange groups into the nonwoven fabric.

Patent Document 1: JP-A-11-290702 (claims)
Patent Document 2: JP-A-8-199480 (claims)
Non-patent Document 1: “Research on quality assessment and quality improvement of activated carbon chemical filter”, Shimizu Corporation Research Report, No. 82 (October, 2005), pp. 27 to 38 (page 28, left column, lines 24 to 32)

### SUMMARY OF THE INVENTION

A chemical filter installed in a clean room or the like is required to maintain a high capability of removing ionic gaseous pollutants for a long period of time (i.e., long life).

However, the chemical filters disclosed in Patent Documents 1 and 2 have a limited life. Such chemical filters also have a problem of decrease in the strength when the amount of introduced ion-exchange groups is increased.

Furthermore, the air in a clean room contains propylene glycol monomethyl ether acetate (PGMEA: CH₃COOCH(CH₃)CH₂OCH₃) because a large amount of PGMEA is used in the exposure step in the semiconductor manufacturing process. The PGMEA is hydrolyzed by the catalytic action of a strong acid into acetic acid which is a pollutant substance which corrodes equipment. For this reason, cation-exchange groups in a chemical filter cause a problem of producing acetic acid by catalyzing hydrolysis of PGMEA (Non-patent Document 1).

Accordingly, an object of the present invention is to provide a chemical filter which has high strength and maintains the capability of removing ionic gaseous pollutants for a long period of time. Another object of the present invention is to provide a chemical filter which not only has high strength and maintains the capability of removing ionic gaseous pollutants for a long period of time, but can also suppress hydrolysis of PGMEA.

As a result of extensive studies for solving the above-mentioned problems related to general technologies, the inventors of the present invention found that (1) a hydroxyl group-containing organic fiber produces a polymer with a high graft ratio by radiation graft polymerization since a large number of ion exchange groups are polymerized, (2) a hydroxyl group-containing organic fiber produces a polymer having a higher strength as a filter material by radiation graft polymerization as compared with an organic fiber having no hydroxyl group since the hydroxyl group-containing organic fiber suffers from less damage by radiation graft polymerization, (3) due to these properties, the hydroxyl group-containing organic fiber can produce a filter material having high strength and a chemical filter having a long life, (4) insufficiency of the ion-exchange capacity of strongly acidic ion-exchange groups can be compensated for by forming the filter in a pleated shape since a carboxyl group is also provided with the capability of removing a basic gas, and for this reason (5) the life of the filter can be extended and hydrolysis of PGMEA can be suppressed by forming the filter in a pleated shape and introducing a specific amount of carboxyl groups even if the amount of strongly acidic ion exchange groups is small. These findings have led to the completion of the present invention.

Specifically, the present invention provides (1) a chemical filter obtained by fabricating a chemical filter material, the chemical filter material being a woven or nonwoven fabric formed from a hydroxyl group-containing organic fiber, the hydroxyl group-containing organic fiber containing cation exchange groups introduced by radiation graft polymerization, the chemical filter material having an ion-exchange capacity of 400 meq/m² or more with respect to the cation exchange groups, and the chemical filter material having a tensile strength of 5 to 20 N/15 mm.

The present invention provides (2) a chemical filter obtained by fabricating a chemical filter material, the chemical filter material being a woven or nonwoven fabric formed in a pleated shape from a hydroxyl group-containing organic fiber, the hydroxyl group-containing organic fiber containing cation exchange groups introduced by radiation graft polymerization, the cation exchange groups being a carboxyl group and a strongly acidic cation exchange group, the chemical filter material having an ion-exchange capacity of 100 meq/m² or more with respect to the carboxyl group, the chemical filter material having an ion-exchange capacity of 300 to 1000 meq/m² with respect to the strongly acidic cation exchange group, and the chemical filter material having a tensile strength of 5 to 20 N/15 mm.

The present invention provides (3) a method for producing a chemical filter comprising preparing a woven or nonwoven fabric by processing a hydroxyl group-containing organic fiber, introducing ion-exchange groups into the hydroxyl group-containing organic fiber in the woven or nonwoven fabric by radiation graft polymerization to obtain a chemical filter material, and fabricating the chemical filter material to obtain a chemical filter.

The present invention provides (4) a method for producing a chemical filter comprising introducing ion-exchange groups into a hydroxyl group-containing organic fiber by radiation graft polymerization, processing the resulting organic fiber into a woven or nonwoven fabric to obtain a chemical filter material, and fabricating the chemical filter material to obtain a chemical filter.

A chemical filter which has high strength and maintains the capability of removing ionic gaseous pollutants for a long period of time can be obtained according to the present invention. A chemical filter which not only has high strength and maintains the capability of removing ionic gaseous pollutants for a long period of time, but also can suppress hydrolysis of PGMEA can be obtained according to the present invention.

### BRIEF DESCRIPTION OF THE DRAWINGS

FIG. 1 is a schematic perspective view showing an example of the chemical filter obtained by fabrication in a pleated shape in the chemical filter preparation method (1) of the present invention.

### DETAILED DESCRIPTION OF THE INVENTION AND PREFERRED EMBODIMENTS

A chemical filter according to a first embodiment of the present invention (hereinafter referred to from time to time as “chemical filter (1)”) is obtained by fabricating a chemical filter material which is a woven or nonwoven fabric formed from a hydroxyl group-containing organic fiber. The hydroxyl group-containing organic fiber contains cation exchange groups introduced therein by radiation graft polymerization. The chemical filter material has an ion-exchange capacity of 400 meq/m² or more with respect to the cation exchange groups, and the chemical filter material has a tensile strength of 5 to 20 N/15 mm.

The chemical filter (1) is obtained by fabricating the above chemical filter material. Although there are no specific limitations to the form of the chemical filter (1), a pleated-type is preferable.

The chemical filter material for obtaining the chemical filter (1) is a woven or nonwoven fabric of hydroxyl group-containing organic fiber. That is, the woven or nonwoven fabric is formed from a hydroxyl group-containing organic fiber.

As examples of the hydroxyl group-containing organic fiber used in the chemical filter (1) of the present invention, naturally occurring fibers and reproduced fibers such as a rayon fiber, a pulp fiber, a cotton fiber, and a cotton-linter fiber can be given. As the hydroxyl group-containing organic fiber, a rayon fiber, a pulp fiber, a cotton fiber, or a cotton-linter fiber or a mixture of two or more of these fibers is preferable. Due to a large hydroxyl group content, these fibers achieve a high graft polymerization rate, introduce a large amount of ion-exchange groups, provide a long filter life, and increase the filter strength. A rayon fiber is particularly preferable among these organic fibers having a hydroxyl group due to its capability of introducing a large amount of ion-exchange groups, which leads not only to a long filter life and high strength, but also to excellent chemical stability. Although not particularly limited, the fiber diameter of the organic fibers having a hydroxyl group is preferably 5 to 20 μm.

The woven or nonwoven fabric for preparing the chemical filter (1) is not particularly limited insofar as the woven or nonwoven fabric is made from the hydroxyl group-containing organic fiber. Among the nonwoven fabrics, a spunlace nonwoven fabric in which the hydroxyl group-containing organic fiber is uniformly dispersed is preferable since ion-exchange groups are uniformly introduced and the chemical filter has a long life.

There are no particular limitations to the method for preparing the nonwoven fabric by processing the hydroxyl group-containing organic fiber. Either a dry method or a wet method may be used. As examples, a resin bond method, a spunlace method, and a wet paper-making method can be given. Among the nonwoven fabrics, a spunlace nonwoven fabric in which the hydroxyl group-containing organic fiber is uniformly dispersed is preferable since ion-exchange groups are uniformly introduced and the chemical filter has a long life. Among the nonwoven fabrics, a spunlace nonwoven fabric made from a rayon fiber which contains a large amount of ion-exchange groups introduced therein and in which the hydroxyl group-containing organic fiber is uniformly dispersed is preferable since a large amount of ion-exchange groups are uniformly introduced and the chemical filter has a long life.

The spunlace method is a method of preparing a spunlace nonwoven fabric by injecting high-pressure water to a web from a nozzle or the like so that the fibers are entangled by the water stream. The water pressure, the amount of treating time, and the like in the spunlace method may be appropriately selected.

The hydroxyl group-containing organic fiber which forms the chemical filter material for obtaining the chemical filter (1) of the present invention has cation-exchange groups introduced by radiation graft polymerization.

Examples of the cation-exchange group used for the chemical filter (1) of the present invention include a sulfonic acid group, a carboxyl group, a phosphoric acid group, a phosphonic acid group, a sulfoethyl group, a phosphomethyl group, a carbomethyl group, and the like. These groups may be used either alone or in combination. Of these cationic ion-exchange groups, the sulfonic acid group is preferable due to its high basic gas adsorption rate.

As the radiation graft polymerization method for obtaining the chemical filter (1) of the present invention (hereinafter referred to from time to time as “radiation graft polymerization (1)”), for example, (i) radiation graft polymerization (1a) which is a method of irradiating a material to be polymerized and coating or impregnating the irradiated material to be polymerized with the polymerizable monomer solution to graft-polymerize the polymerizable monomer by radiation and (ii) radiation graft polymerization (1b) which is a method of first coating or impregnating the material to be polymerized with the polymerizable monomer solution and irradiating the material to graft polymerize the polymerizable monomer can be given. In the radiation graft polymerization (1a) and the radiation graft polymerization (1b), the atmosphere is replaced with an inert gas such as nitrogen prior to irradiation to carry out the graft polymerization in an inert gas atmosphere. The “material to be polymerized” in the present invention refers to an object to be graft polymerized by radiation into which the polymer chains of the polymerizable monomer are to be introduced. The radiation graft polymerization (1b) is preferred. Since the method causes only minor damage to the hydroxyl group-containing organic fiber, it is possible to increase the strength of the material for a producing chemical filter compared to a conventional art. In addition, since the inert gas atmosphere such as nitrogen gas is only necessary when coating or impregnating the material to be polymerized with the polymerizable monomer solution, an incident of oxygen shortage and a cost increase due to the use of inert gas can be obviated.

As examples of the polymerizable monomer used in the radiation graft polymerization (1) (hereinafter referred to from time to time as “polymerizable monomer (1)”), sodium styrene sulfonate, 2-acrylamide-2-methylpropanesulfonic acid, sodium 2-acrylamide-2-methylpropanesulfonate, acrylic acid, and methacrylic acid can be given.

In the case of the polymerizable monomer (1) having a salt group of the cation-exchange group, the salt group of the cation-exchange group may be converted into the cation-exchange group (proton-type) by an acid treatment after the radiation graft polymerization. The salt group of the cation-exchange group refers to a neutralized cation-exchange group such as a sodium sulfonate group (—SO₃Na) of sodium styrene sulfonate, for example.

As examples of the radiation used in the radiation graft polymerization, ultraviolet rays, electron beams, X rays, α-rays, β-rays, and γ-rays can be given. Of these, γ-rays are preferable. The dose of radiation used in the radiation graft polymerization may be appropriately selected according to the degree of graft polymerization. Usually, 10 to 400 kGy is preferable when γ-rays are used.

As examples of the solvent for the polymerizable monomer (1) used in the radiation graft polymerization (1), hydrophilic solvents such as water and alcohol can be given. The concentration of the polymerizable monomer (1) in the monomer solution may be appropriately selected, preferably from the range of 40 to 70 mass %.

In the chemical filter (1) of the present invention, the ion-exchange capacity of the chemical filter material is 400 meq/m² or more, and preferably 600 to 1600 meq/m² with respect to the cation exchange groups. If the ion-exchange capacity of the chemical filter material is in the above range, the chemical filter has a long life.

In the chemical filter (1) of the present invention, the tensile strength of the chemical filter material is 5 to 20 N/15 mm, and preferably 10 to 15 N/15 mm.

In the chemical filter (1) of the present invention, the basis weight of the chemical filter material is preferably 50 to 200 g/m³, and particularly preferably 100 to 160 g/m³. The thickness of the chemical filter material is preferably 0.3 to 1.5 mm, and particularly preferably 0.6 to 1.2 mm.

A chemical filter according to a second embodiment of the present invention (hereinafter referred to from time to time as “chemical filter (2)”) is obtained by fabricating a chemical filter material which is a woven or nonwoven fabric formed from a hydroxyl group-containing organic fiber. The chemical filter (2) has a pleated shape and the hydroxyl group-containing organic fiber contains cation exchange groups introduced by radiation graft polymerization. The cation exchange groups are a carboxyl group and a strongly acidic cation exchange group. The chemical filter material has an ion-exchange capacity of 100 meq/m² or more with respect to the carboxyl group and the chemical filter material has an ion-exchange capacity of 300 to 1000 meq/m² with respect to the strongly acidic cation exchange group. The chemical filter material has a tensile strength of 5 to 20 N/15 mm.

The chemical filter (2) is obtained by fabricating the above chemical filter material.

The chemical filter material for obtaining the chemical filter (2) is a woven or nonwoven fabric of a hydroxyl group-containing organic fiber. That is, the woven or nonwoven fabric is formed from a hydroxyl group-containing organic fiber. The chemical filter material is processed into a pleated shape.

The hydroxyl group-containing organic fiber used in the chemical filter (2) is the same as the hydroxyl group-containing organic fiber as used in the chemical filter (1).

The woven or nonwoven fabric used in the chemical filter (2) is the same as the woven or nonwoven fabric as used in the chemical filter (1).

The hydroxyl group-containing organic fiber which forms the chemical filter material for obtaining the chemical filter (2) of the present invention has cation-exchange groups introduced by radiation graft polymerization. The cation-exchange groups used in the chemical filter (2) are a carboxyl group (—COOH) and a strongly acidic cation-exchange group. That is, the chemical filter of the present invention has both a carboxyl group and a strongly acidic cation-exchange group introduced therein.

As the strongly acidic cation-exchange group used in the present invention, a sulfonic acid group (—SO₃H) can be given.

The radiation graft polymerization for obtaining the chemical filter (2) of the present invention (hereinafter referred to from time to time as “radiation graft polymerization (2)”) is the same as the radiation graft polymerization (1) except for using the following polymerizable monomers (2).

A mixture of a polymerizable monomer having a carboxyl group (—COOH) such as acrylic acid and methacrylic acid (polymerizable monomer (2c)) and a polymerizable monomer having a strongly acidic cation-exchange group (polymerizable monomer (2d)) is used as the polymerizable monomer (2) in the radiation graft polymerization (2). As examples of the polymerizable monomer (2d), sodium styrene sulfonate, 2-acrylamide-2-methylpropanesulfonic acid, sodium 2-acrylamide-2-methylpropanesulfonate, and sodium allyl sulfonate can be given. In the case of the polymerizable monomer (2) having a salt group of the cation-exchange group, the salt group of the cation-exchange group may be converted into the cation-exchange group (proton-type) by an acid treatment after the radiation graft polymerization.

As examples of the radiation used in the radiation graft polymerization (2), ultraviolet rays, electron beams, X rays, α-rays, β-rays, and γ-rays can be given. Of these, γ-rays are preferable. The dose of radiation used in the radiation graft polymerization may be appropriately selected according to the degree of graft polymerization. Usually, 10 to 400 kGy is preferable when γ-rays are used.

As examples of the solvent for the polymerizable monomer used in the radiation graft polymerization (2), hydrophilic solvents such as water and alcohol can be given. The concentration of the polymerizable monomer (2) in the monomer solution may be appropriately selected, preferably from the range of 40 to 70 mass %.

In the chemical filter (2) of the present invention, the ion-exchange capacity of the chemical filter material is 100 meq/m² or more, and preferably 400 to 900 meq/m² with respect to the carboxyl groups. The ion-exchange capacity of the chemical filter material is 300 to 1000 meq/m², and preferably 500 to 800 meq/m² with respect to the strongly acidic cation exchange groups. The ion-exchange capacity of the carboxyl group and the strongly acidic cation exchange group in the chemical filter material in the above range suppresses hydrolysis of PGMEA and extends the life of the chemical filter.

In the chemical filter (2) of the present invention, the tensile strength of the chemical filter material is 5 to 20 N/15 mm, and preferably 10 to 15 N/15 mm.

In the chemical filter (2) of the present invention, the basis weight of the chemical filter material is preferably 50 to 200 g/m², and particularly preferably 100 to 160 g/m². The thickness of the chemical filter material is preferably 0.3 to 1.5 mm, and particularly preferably 0.6 to 1.2 mm.

The ion-exchange capacity of the chemical filter material of the present invention is measured by neutralization titration using a sodium hydroxide aqueous solution. The ion-exchange capacity of the strongly acidic cation-exchange group in the chemical filter material is measured by replacing the strongly acidic cation-exchange group with a sodium ion using a sodium chloride solution and neutralization titration of the resulting hydrochloric acid using a sodium hydroxide aqueous solution. The ion-exchange capacity of the carboxyl group in the chemical filter material is calculated by subtracting the ion-exchange capacity of the strongly acidic cation-exchange group from the total ion-exchange capacity.

The chemical filter (1) and chemical filter (2) of the present invention can be suitably used as a chemical filter installed in a clean room or in equipment used in a clean room of a plant for manufacturing semiconductor devices, liquid crystal displays, and precision electronic components.

A method for producing the chemical filter according to the first embodiment of the present invention (hereinafter referred to from time to time as “chemical filter production method (1)”) comprises preparing a woven or nonwoven fabric by processing a hydroxyl group-containing organic fiber, introducing ion-exchange groups into the hydroxyl group-containing organic fiber in the woven or nonwoven fabric by radiation graft polymerization to obtain a chemical filter material, and fabricating the chemical filter material.

In the chemical filter production method (1) of the present invention, a woven or nonwoven fabric is first produced by processing a hydroxyl group-containing organic fiber.

The hydroxyl group-containing organic fiber used in the chemical filter production method (1) of the present invention is the same as the hydroxyl group-containing organic fiber of the chemical filter (1).

There are no particular limitations to the method for preparing the nonwoven fabric by processing the hydroxyl group-containing organic fiber in the chemical filter production method (1). Either a dry method or a wet method may be used. As examples, a resin bond method, a spunlace method, and a wet paper-making method can be given. Among the nonwoven fabrics, a spunlace nonwoven fabric in which the hydroxyl group-containing organic fiber is uniformly dispersed is preferable since ion-exchange groups are uniformly introduced and the chemical filter has a long life. Among the nonwoven fabrics, a spunlace nonwoven fabric made from a rayon fiber which contains a large amount of ion-exchange groups introduced therein and in which the hydroxyl group-containing organic fiber is uniformly dispersed is preferable since a large amount of ion-exchange groups are uniformly introduced and the chemical filter has a long life.

The spunlace method is a method of preparing a spunlace nonwoven fabric by injecting high-pressure water to a web from a nozzle or the like so that the fibers are entangled by the water stream. The water pressure, the amount of treating time, and the like in the spunlace method may be appropriately selected.

The water absorption rate of the woven or nonwoven fabric obtained in this manner before introducing ion-exchange groups is preferably 50 to 300 mass %, and particularly preferably 150 to 250 mass %. The water adsorption rate of the woven or nonwoven fabric before introducing the ion-exchange group in the above range enables a large amount of ion-exchange groups to be introduced into the nonwoven fabric, resulting in a chemical filter having high performance of eliminating ionized gaseous pollutants and also a long life.

The water absorption rate of the woven or nonwoven fabric can be determined by the following method. First, the woven or nonwoven fabric is dipped in water by placing the fabric almost parallel to the water surface to cause the woven or nonwoven fabric to absorb water. Then, the woven or nonwoven fabric which has adsorbed water is removed from the water by drawing the fabric from the water while maintaining the state of being almost parallel to the water surface. The woven or nonwoven fabric is then held above the water until no more water drips therefrom. The water adsorption rate of the woven or nonwoven fabric is calculated using the following formula (1).

Water absorption rate (%)={(B−A)/A}×100 (1)

wherein A is the mass (g) of the woven or nonwoven fabric before adsorbing water, and B is the mass (g) of the woven or nonwoven fabric when no more water drips therefrom.

In the chemical filter production method (1) of the present invention, ion-exchange groups are introduced into the hydroxyl group-containing organic fiber of the resulting woven or non-woven fabric by radiation graft polymerization.

The ion-exchange group introduced into the hydroxyl group-containing organic fiber of the woven or nonwoven fabric may be either a cation-exchange group or an anion-exchange group. Examples of the cation-exchange group include a sulfonic acid group, a carboxyl group, a phosphoric acid group, a phosphonic acid group, a sulfoethyl group, a phosphomethyl group, a carbomethyl group, and the like. These groups may be used either alone or in combination of two or more. Of these cationic ion-exchange groups, the sulfonic acid group is preferable due to the high basic gas adsorption rate. As the anion-exchange group, a quaternary ammonium group, a primary amino group, a secondary amino group, a tertiary amino group, a methyl amino group, and the like can be given. These groups may be used either alone or in combination of two or more. Of these anion-exchange groups, the quaternary ammonium group is preferable due to the high acidic gas adsorption rate.

As the radiation graft polymerization used in the chemical filter production method (1) of the present invention (hereinafter referred to from time to time as “radiation graft polymerization (3)”), radiation graft polymerizable (3a), which is a method of irradiating a material to be polymerized and coating or impregnating the irradiated material to be polymerized with the polymerizable monomer solution to graft-polymerize the polymerizable monomer, and radiation graft polymerization (3b), which is a method of first coating or impregnating the material to be polymerized with the polymerizable monomer solution and irradiating the material to be polymerized coated or impregnated with the polymerizable monomer solution to graft polymerize the polymerizable monomer, can be given. In the radiation graft polymerization (3a) and the radiation graft polymerization (3b), the atmosphere is replaced with an inert gas such as nitrogen prior to irradiation to carry out the graft polymerization in an inert gas atmosphere. The radiation graft polymerization (3b) is preferred. Since the method causes only a minor damage to the hydroxyl group-containing organic fiber, it is possible to increase the strength of the material for producing chemical filter compared to a conventional art. In addition, since the inert gas atmosphere such as nitrogen gas is only necessary when coating or impregnating the material to be polymerized with the polymerizable monomer solution, an incident of oxygen shortage and a cost increase due to the use of inert gas can be obviated.

The polymerizable monomer used for the radiation graft polymerization (3) (hereinafter referred to from time to time as “polymerizable monomer (3)”) include a polymerizable monomer having a cation-exchange group, a polymerizable monomer having a salt group of the cation-exchange group, a polymerizable monomer having an anion-exchange group, a polymerizable monomer having a salt group of the anion-exchange group, a polymerizable monomer having a substituent of which the functional group is convertible into an ion-exchange group by an appropriate method.

As examples of the polymerizable monomer (3) when the ion-exchange group introduced into the woven or nonwoven fabric is a cation-exchange group, sodium styrene sulfonate, 2-acrylamide-2-methylpropanesulfonate, sodium 2-acrylamide-2-methylpropanesulfonate, acrylic acid, methacrylic acid, and sodium allylsulfonate can be given. In the case of the polymerizable monomer (3) having a salt group of the cation-exchange group, the salt group of the cation-exchange group may be converted into the cation-exchange group (proton-type) by an acid treatment after the radiation graft polymerization.

When both a carboxyl group and a strongly acidic cation-exchange group are introduced into the woven or nonwoven fabric as the ion-exchange group, the polymerizable monomer (3) is a mixture of a polymerizable monomer having a carboxyl group such as acrylic acid and methacrylic acid (polymerizable monomer (3c)) and a polymerizable monomer having a strongly acidic cation-exchange group (polymerizable monomer (3d)). As examples of the polymerizable monomer (3c), acrylic acid and methacrylic acid can be given. As examples of the polymerizable monomer (3d), sodium styrene sulfonate, 2-acrylamide-2-methylpropanesulfonic acid, sodium 2-acrylamide-2-methylpropanesulfonate, and the like can be given. The ratio of the ion-exchange capacity of the carboxyl group and the strongly acidic cation-exchange group in the chemical filter material can be adjusted by selecting the molar ratio of the polymerizable monomer (3c) and the polymerizable monomer (3d).

When the ion-exchange group introduced into the woven or nonwoven fabric is an anion-exchange group, vinylbenzyltrimethyl ammonium salt, diethylaminoethyl methacrylate, dimethylaminoethyl acrylate, and dimethylaminoethyl methacrylate can be given as examples of the polymerizable monomer (3) used for the graft polymerization. These polymerizable monomers may be used either individually or in combination of two or more. In the case of the polymerizable monomer having a salt group of the anion-exchange group, the salt group of the anion-exchange group may be converted into the anion-exchange group (hydroxyl group-type) by an alkali treatment after radiation graft polymerization.

As examples of the radiation used in the radiation graft polymerization (3), ultraviolet rays, electron beams, X rays, α-rays, β-rays, and γ-rays can be given. Of these, γ-rays are preferable. The dose of radiation used in the radiation graft polymerization may be appropriately selected according to the degree of graft polymerization. Usually, 10 to 400 kGy is preferable when γ-rays are used.

As examples of the solvent for the polymerizable monomer used in the radiation graft polymerization (3), hydrophilic solvents such as water and alcohol can be given. The concentration of the polymerizable monomer (3) in the monomer solution may be appropriately selected, preferably from the range of 40 to 70 mass %.

When the radiation graft polymerization (3) is the radiation graft polymerization (3b), that is, when the method of first coating or impregnating the woven or nonwoven fabric with the polymerizable monomer solution to obtain the woven or nonwoven fabric coated or impregnated with the polymerizable monomer solution and exposing the woven or nonwoven fabric to radiation to graft polymerize the polymerizable monomer is used, the impregnation rate of the polymerizable monomer in the woven or nonwoven fabric is preferably 50 to 300 mass %, and particularly preferably 150 to 250 mass %. The impregnation rate of the polymerizable monomer in the woven or nonwoven fabric in the above range enables a large amount of ion-exchange groups to be introduced into the woven or nonwoven fabric, resulting in a chemical filter having high performance of eliminating ionized gaseous pollutants and also a long life. In the chemical filter production method (1) of the present invention, the woven or non-woven fabric can be coated or impregnated with a large amount of the polymerizable monomer solution since the woven or non-woven fabric is made from hydroxyl group-containing organic fiber. The resulting chemical filter material is therefore provided with a large ion-exchange capacity. The impregnation rate of the polymerizable monomer in the woven or nonwoven fabric of the present invention can be determined by the following formula (2).

Impregnation rate of polymerizable monomer in woven or nonwoven fabric (%)={(D−C)/C}×100 (2)

wherein C is the mass (g) of the woven or nonwoven fabric before being coated or impregnated with the polymerizable monomer solution, and D is the mass (g) of the woven or nonwoven fabric after having been coated or impregnated with the polymerizable monomer solution.

When the woven or nonwoven fabric is coated or impregnated with the polymerizable monomer solution in an amount exceeding the amount which can be adsorbed by the woven or nonwoven fabric, water drips from the woven or nonwoven fabric which is held almost horizontally. The mass of the woven or nonwoven fabric when no more water drips therefrom is regarded as the mass D (g) of the woven or nonwoven fabric after having been coated or impregnated with the polymerizable monomer solution.

Then, the chemical filter material having the ion-exchange groups introduced therein can be obtained by introducing the ion-exchange groups into the hydroxyl group-containing organic fiber in the woven or nonwoven fabric by radiation graft polymerization.

In the chemical filter production method (1) of the present invention, the resulting chemical filter material is processed to obtain the chemical filter.

The method of fabricating the chemical filter material and the form of the processed chemical filter can be appropriately selected without a particular limitation in the chemical filter production method (1) of the present invention. For example, pleat fabrication for obtaining a pleated-type chemical filter and a corrugate fabrication for obtaining a honeycomb-type filter can be given.

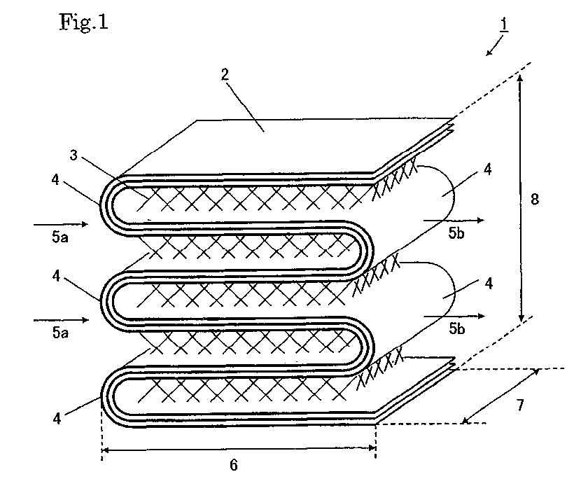

As an example of the method for processing the chemical filter material, a pleat fabrication method is explained. FIG. 1 is a schematic perspective view showing an example of the chemical filter obtained by pleat fabrication in the chemical filter preparation method (1) of the present invention. A chemical filter 1 shown in FIG. 1 is obtained by pleat fabrication by layering three sheets of the chemical filter material 2 and folding the three layered sheets at the crease 4. A spacer 3 is provided between corrugations of the chemical filter material 2 in order to prevent the folded sections of chemical filter material 2 from coming in contact with each other. Air to be processed is caused to flow through the chemical filter 1 in the direction vertical to the creases 4 of the chemical filter material 2 (direction indicated by arrows 5a and 5b). In FIG. 1, although three sheets of the chemical filter material 2 are layered, the number of sheet is not limited to three. Usually 1 to 4 sheets, and preferably 2 or 3 sheets are used.

A method for producing the chemical filter according to the second of the present invention (hereinafter referred to from time to time as “chemical filter production method (2)”) comprises introducing ion-exchange groups into a hydroxyl group-containing organic fiber by radiation graft polymerization, processing the obtained organic fiber into a woven or nonwoven fabric to obtain a chemical filter material, and fabricating the chemical filter material in which the ion-exchange groups have been introduced.

The chemical filter production method (2) differs from the chemical filter production method (1) in the order of processing the hydroxyl group-containing organic fiber into the woven or nonwoven fabric. That is, in the chemical filter production method (1), the hydroxyl group-containing organic fiber is processed into the woven or nonwoven fabric before introducing ion-exchange group therein, whereas, in the chemical filter production method (2), the ion-exchange group is first introduced into the hydroxyl group-containing organic fiber by radiation graft polymerization.

The hydroxyl group-containing organic fiber used in the chemical filter production method (2) is the same as the hydroxyl group-containing organic fiber used in the chemical filter production method (1).

The ion-exchange groups used in the chemical filter production method (2) is the same as the ion-exchange groups used in the chemical filter production method (1).

The radiation graft polymerization in the chemical filter production method (2) is the same as the radiation graft polymerization performed in the chemical filter production method (1), except that the object of polymerization is the hydroxyl group-containing organic fiber before being processed into the woven or nonwoven fabric in the chemical filter production method (2), whereas in the chemical filter, production method (1), the woven or nonwoven fabric obtained from the hydroxyl group-containing organic fiber is the object of polymerization.

In the chemical filter production method (2), the ion-exchange groups are introduced into the hydroxyl group-containing organic fiber by radiation graft polymerization to obtain the hydroxyl group-containing organic fiber in which the ion-exchange groups have been introduced.

In the chemical filter production method (2) of the present invention, the hydroxyl group-containing organic fiber in which the ion-exchange groups have been introduced is processed into the woven or non-woven fabric.

The method of producing a woven or nonwoven fabric by processing the hydroxyl group-containing organic fiber having ion-exchange groups introduced therein in the chemical filter production method (2) is the same as method of producing a woven or nonwoven fabric by processing the hydroxyl group-containing organic fiber in the chemical filter production method (1), except that the fabric to be processed is the hydroxyl group-containing organic fiber having ion-exchange groups introduced therein in the former method, whereas in the latter method the fabric to be processed is the hydroxyl group-containing organic fiber.

In the chemical filter production method (2), the ion-exchange groups are introduced into the hydroxyl group-containing organic fiber in which the ion-exchange groups have been introduced by radiation graft polymerization to obtain the chemical filter material having ion-exchange groups introduced therein.

The same chemical filter material as that produced by the chemical filter production method (1) can be obtained by the chemical filter production method (2).

In the chemical filter production method (2) of the present invention, the resulting chemical filter material is fabricated into a chemical filter. The same method of fabricating the chemical filter material into a chemical filter as used in the chemical filter production method can be applied to the chemical filter production method (1).

The chemical filter obtained by the chemical filter production method (1) and the chemical filter production method (2) of the present invention can be suitably used as a chemical filter installed in a clean room or in equipment used in a clean room of a plant for manufacturing semiconductor devices, liquid crystal displays, and precision electronic components.

The chemical filter production method (1) and the chemical filter production method (2) can be suitably used for producing the chemical filter (1) and the chemical filter (2). For example, the chemical filter (1) of the present invention can be produced by suitably adjusting the types and combination of the polymerizable monomers, the impregnation amount of the polymerizable monomer used for the object to be polymerized, and the amount of ion-exchange groups to be introduced. The chemical filter (2) of the present invention can be produced by suitably adjusting the combination and the molar ratio of the polymerizable monomer (3c) and the polymerizable monomer (3d), the impregnation amount of the polymerizable monomer used for the object to be polymerized, and the amount of carboxyl group and strongly acidic ion-exchange groups to be introduced.

The chemical filters (1) and (2), as well as the chemical filters obtained by the chemical filter production method (1) and the chemical filter production method (2) have high strength of the filter material and a long life.

Since the chemical filter (2) of the present invention is produced from the chemical filter material having a pleated shape, the chemical filter (2) has a larger contact area with the air to be processed. For this reason, the carboxyl group of which the reaction rate with a basic gas is smaller as compared with a strongly acidic cation-exchange group can function as a cation-exchange group for removing the basic gas in the air to be processed.

In the chemical filter (2), the life of the chemical filter can be extended by increasing the ion-exchange capacity of the carboxyl group without excessively increasing the ion-exchange capacity of the strongly acidic cation-exchange group. For these reasons, it is possible to expand the life of the chemical filter (2) by controlling the ion-exchange capacity of the carboxyl group and the ion-exchange capacity of the strongly acidic cation-exchange group in a specific range. In addition, since it is possible to reduce the ion-exchange capacity of the strongly acidic cation-exchange group which exhibits the catalytic activity of hydrolyzing PGMEA, hydrolysis of PGMEA can be suppressed.

The present invention will be described in more detail by examples, which should not be construed as limiting the present invention.

### EXAMPLES

### Example 1

### Preparation of Chemical Filter Material

A spunlace rayon nonwoven fabric with a basis weight of 160 g/m², a thickness of 1.1 mm, and a fiber diameter of about 20 μm was prepared by a spunlace method. An aqueous solution of a polymerizable monomer containing 50 mass % of 2-acrylamide-2-methylpropanesulfonic acid and 10 mass % of acrylic acid was applied to the resulting spunlace rayon nonwoven fabric in an amount of 320 g/m². The impregnation rate of the spunlace rayon nonwoven fabric with the monomer solution was 200%.

The nonwoven fabric provided with the monomer aqueous solution was irradiated with γ-rays in a nitrogen atmosphere. The dose of radiation was 100 kGy. The ion-exchange capacity of the chemical filter material was 1095 meq/m², the ion-exchange capacity of the chemical filter material was 400 meq/m² with respect to the carboxyl group, and the ion-exchange capacity of the chemical filter material was 695 meq/m² with respect to the strongly acidic ion-exchange groups. The tensile strength of the chemical filter material was measured and found to be 13 N/15 mm. The tensile strength of the chemical filter material was measured according to JIS P8113:1998.

### (Production of Chemical Filter)

A chemical filter was prepared from the resulting chemical filter material by pleat fabrication.

### <Specification>

Dimensions of chemical filter: thickness: 150 mm, width: 130 mm, height: 130 mm (thickness: 6 in FIG. 1, width: 7 in FIG. 1, height: 8 in FIG. 1)
Folding pitch: 85 creases/m

### (Life Test of Chemical Filter)

A life test was conducted on the chemical filter thus obtained under the following conditions using ammonia (i.e., removal target gas). The period of time elapsed up to the time when the removal rate decreased to 90% was regarded as the life of the chemical filter. The life of the chemical filter was 350 hours.

The ammonia concentration causing problems in a clean room or the like is in the order of ppb by volume. In the examples, an ammonia concentration of 2000 ppb by volume was used (accelerated test).

### <Test Conditions>

Target gas: ammonia (2000 ppb by volume)
Gas feed rate (Face velocity): 0.5 m/sec

### Comparative Example 1

### Preparation of Chemical Filter Material

A thermal bond nonwoven fabric with a basis weight of 160 g/cm², a thickness of 1.1 mm, and a fiber diameter of about 20 μm was prepared from a fiber with a core-sheath structure (core: polyethyleneterephthalate, sheath: polyethylene) by a thermal bond method. A polymerizable monomer aqueous solution containing 50 mass % of 2-acrylamide-2-methylpropanesulfonic acid and 10 mass % of acrylic acid was applied to the resulting thermal-bonded nonwoven fabric. Notwithstanding the attempt of applying 320 g/m², only 220 g/m² was applied to the nonwoven fabric, with the balance having been repelled and dripped. The impregnation rate of the thermal-bonded nonwoven fabric with the monomer solution was 138%.

The nonwoven fabric provided with the polymerizable monomer aqueous solution was irradiated with γ-rays in a nitrogen atmosphere. The dose of radiation was 100 kGy. The ion-exchange capacity of the chemical filter material was 753 meq/m², the ion-exchange capacity of the chemical filter material was 275 meq/m² with respect to the carboxyl group, and the ion-exchange capacity of the chemical filter material was 478 meq/m² with respect to the strongly acidic ion-exchange groups. The tensile strength of the chemical filter material was 9 N/15 mm.

### (Fabrication of Chemical Filter)

A chemical filter was fabricated in the same manner as in Example 1 except for using the chemical filter material obtained above.

### (Life Test of Chemical Filter)

The life test was carried out in the same manner as in Example 1, except for using the chemical filter obtained above. As a result, the life of the chemical filter was 241 hours.

### Example 2

### Preparation of Chemical Filter Material

A spunlace rayon nonwoven fabric with a basis weight of 160 g/m², a thickness of 1.1 mm, and a fiber diameter of about 20 μm was prepared by a spunlace method. A polymerizable monomer aqueous solution containing 40 mass % of 2-acrylamide-2-methylpropanesulfonic acid and 20 mass % of acrylic acid was applied to the resulting spunlace rayon nonwoven fabric in an amount of 320 g/m². The impregnation rate of the spunlace rayon nonwoven fabric with the monomer solution was 200%.

The nonwoven fabric coated with the polymerizable monomer aqueous solution was irradiated with γ-rays in a nitrogen atmosphere. The dose of radiation was 100 kGy. The ion-exchange capacity of the chemical filter material was 1356 meq/m², the ion-exchange capacity of the chemical filter material was 800 meq/m² with respect to the carboxyl group, and the ion-exchange capacity of the chemical filter material was 556 meq/m² with respect to the strongly acidic ion-exchange groups. The tensile strength of the chemical filter material was 13 N/15 mm.

### (Fabrication of Chemical Filter)

A chemical filter was fabricated in the same manner as in Example 1 except for using the chemical filter material obtained above.

### (Life Test of Chemical Filter)

The life test was carried out in the same manner as in Example 1, except for using the chemical filter obtained above. The life of the chemical filter was 280 hours.

### (Amount of Acetic Acid Generated by Processing of Gas Containing PGMEA)

Gas with a PGMEA concentration of 2000 μg/m³ was passed through the chemical filter at a rate of 0.5 m/sec. No acetic acid generation was confirmed at the filter exit.

### Example 3

A spunlace rayon nonwoven fabric with a basis weight of 160 g/m², a thickness of 1.1 mm, and a fiber diameter of about 20 μm was prepared by a spunlace method. A polymerizable monomer aqueous solution containing 70 mass % of 2-acrylamide-2-methylpropanesulfonic acid was applied to the resulting spunlace rayon nonwoven fabric in an amount of 400 g/m². The impregnation rate of the spunlace rayon nonwoven fabric with the monomer solution was 250%.

The nonwoven fabric coated with the polymerizable monomer aqueous solution was irradiated with γ-rays in a nitrogen atmosphere. The dose of radiation was 100 kGy. The ion-exchange capacity of the chemical filter material was 1218 meq/m² with respect to the strongly acidic ion-exchange group. The tensile strength of the chemical filter material was 13 N/15 mm.

### (Fabrication of Chemical Filter)

A chemical filter was fabricated in the same manner as in Example 1 except for using the chemical filter material obtained above.

### (Life Test of Chemical Filter)

The life test was carried out in the same manner as in Example 1, except for using the chemical filter obtained above. As a result, the life of the chemical filter was 612 hours.

### (Amount of Acetic Acid Generated by Processing of Gas Containing PGMEA)

Gas with a PGMEA concentration of 2000 μg/m³ was passed through the chemical filter at a rate of 0.5 msec. Acetic acid generation was confirmed at the filter exit and the concentration of the acetic acid was 150 μg/m³.

According to the present invention, a chemical filter having high strength, exhibiting high ionic gaseous pollutant removal performance, and having a long life can be obtained.

What is claimed is:

1. A chemical filter obtained by fabricating a chemical filter material, the chemical filter material being a woven or nonwoven fabric formed from a hydroxyl group-containing organic fiber, the hydroxyl group-containing organic fiber containing cation exchange groups introduced by radiation graft polymerization, the chemical filter material having an ion-exchange capacity of 400 meq/m² or more with respect to the cation exchange groups, and the chemical filter material having a tensile strength of 5 to 20 N/15 nun.

2. A chemical filter obtained by fabricating a chemical filter material, the chemical filter material being a woven or nonwoven fabric formed in a pleated shape from a hydroxyl group-containing organic fiber, the hydroxyl group-containing organic fiber containing cation exchange groups introduced by radiation graft polymerization, the cation exchange groups being a carboxyl group and a strongly acidic cation exchange group, the chemical filter material having an ion-exchange capacity of 100 meq/m² or more with respect to the carboxyl group, the chemical filter material having an ion-exchange capacity of 300 to 1000 meq/m² with respect to the strongly acidic cation exchange group, and the chemical filter material having a tensile strength of 5 to 20 N/15 mm.

3. The chemical filter according to claim 2, wherein the strongly acidic cation exchange group is a sulfonic acid group.

4. The chemical filter according to any one of claim 1 or 3, wherein the organic fiber is at least one of a rayon fiber, a pulp fiber, a cotton fiber, and a cotton-linter fiber.

5. A method for producing a chemical filter comprising preparing a woven or nonwoven fabric by processing a hydroxyl group-containing organic fiber, introducing ion-exchange groups into the hydroxyl group-containing organic fiber in the woven or nonwoven fabric by radiation graft polymerization to obtain a chemical filter material, and fabricating the chemical filter material to obtain a chemical filter.

6. A method for producing a chemical filter comprising introducing ion-exchange groups into a hydroxyl group-containing organic fiber by radiation graft polymerization, processing the resulting organic fiber into a woven or nonwoven fabric to obtain a chemical filter material, and fabricating the chemical filter material to obtain a chemical filter.

7. The method for producing a chemical filter according to claim 5 or 6, wherein the organic fiber is at least one of a rayon fiber, a pulp fiber, a cotton fiber, and a cotton-linter fiber.

8. The method for producing a chemical filter according to claim 7, wherein the woven or nonwoven fabric is impregnated with a monomer solution in an amount of 50 to 300 mass % before the ion-exchange groups are introduced by radiation graft polymerization.
